(19) United States
(12) Patent Application Publication
(10) Pub. No.: US 2011/0274876 A1
(43) Pub. Date: Nov. 10, 2011

(54) Three-dimensional board structure and method for making the same

(76) Inventor: Chao-Lang Wang, Xizhi City (TW)

(21) Appl. No.: 12/801,985

(22) Filed: Jul. 7, 2010

(30) Foreign Application Priority Data
May 5, 2010 (TW) 099114374

(51) Int. Cl. B32B 3/10; B32B 38/04

(52) U.S. Cl. 428/137; 156/253

(57) ABSTRACT

The present invention is to provide a three-dimensional board structure and method thereof by sequentially coating an adhesive on a plurality of veneers containing plant fibers, sequentially bonding the veneers together to form a multilayer board, penetrating and pressing the multilayer board by using a plurality of spikes arranged on a tool for deforming and breaking the plant fibers around peripheries of penetrated portions of the veneers, and removing the spikes from the multilayer board, such that the plant fibers around the peripheries of the penetrated portions of any two adjacent veneers are entangled with each other to form three-dimensional connecting portions in the multilayer board. Since the adhesive will permeate into the three-dimensional connecting portions due to penetration of the spikes and pressure of the tool, the three-dimensional connecting portions between the adjacent veneers and the adhesive permeated therein make the multilayer board having a three-dimensional bonding strength accordingly.

### FIELD OF THE INVENTION

The present invention relates to a board structure, more particularly to a three-dimensional board structure composed of a plurality of veneers containing plant fibers, wherein penetrated portions are provided at corresponding positions of the veneers after a plurality of spikes arranged on a tool penetrate the veneers, and the plant fibers around the peripheries of the penetrated portions of any two adjacent veneers are entangled with each other to form three-dimensional connecting portions in the board structure. Since an adhesive applied between each two adjacent veneers will permeate into the three-dimensional connecting portions due to penetration of the spikes and pressure of the tool applied to the veneers. In addition to a two-dimensional bonding strength provided by the adhesive between each two adjacent veneers, the three-dimensional connecting portions and the adhesive permeated therein also make the board structure having a three-dimensional bonding strength accordingly.

### BACKGROUND OF THE INVENTION

For the past few decades, countries around the world have endeavored to develop economy and the technological industry while neglecting environmental protection. Not only are people generally unaware of the importance of soil and water conservation and forest resources protection, but also tropical rainforests and woods on slope lands were felled at will for the sake of livelihood or economic benefits. In consequence, recent years have seen the following abnormalities in the ecology of the Earth:

1. The number of biological species in tropical rainforests has decreased drastically;
2. Desertification of arid lands has accelerated;
3. With fewer and fewer trees to absorb carbon dioxide for photosynthesis, the carbon dioxide content in the atmosphere has increased, causing the greenhouse effect; and
4. The frequency of debris flow on slope lands has risen.

In view of the above and in order to reduce the environmental impact of felling naturally grown trees whose growth periods are relatively long (e.g., several decades), many countries have passed laws to prohibit the exploitation of virgin forests. Meanwhile, it is encouraged to make wood boards out of farmed trees with relatively short growth periods (e.g., three to seven years), to make plywood with veneers peeled from the trunks or branches of farmed trees, and to use these boards or plywood in the construction of buildings and furniture. Therefore, as timber from natural forests is depleting, it is an inevitable trend to replace boards or plywood made of naturally grown trees with those made of farmed trees. The conventional steps of making plywood from the trunks or branches of farmed trees are detailed as follows:

1. Generally, waste wood material (e.g., wood chips or shavings) or recycled wood material (e.g., a mixture of waste wood material and waste plastics) is added with a resin or adhesive and pressed into veneers. Alternatively, veneers are directly peeled from the trunks or branches of farmed trees.
2. Then, the veneers are coated with an adhesive (e.g., a glue, resin, or other tacky fluid) and stacked and bonded together, such that a two-dimensional bonding strength develops between each two adjacent veneers.
3. Finally, the bonded veneers are pressed and dried to produce the so-called “plywood”.

However, market surveys have shown that commercially available plywood has the following drawbacks in use:

1. As stated above, the conventional plywood is made by bonding and pressing a plurality of veneers together, and in consequence, the bonding strength provided by the adhesive between each two adjacent veneers is only two-dimensional. By contrast, the structural strength of a natural wood board is three-dimensional. Therefore, when the conventional plywood is subjected to a heavy load or impact, the two-dimensionally bonded veneers tend to separate due to the discontinuous bond therebetween, hence warping or deforming the plywood.
2. As the veneers for making plywood are of relatively low compactness, external moisture is very likely to penetrate the gaps in the veneers and thus dampen the veneers. Should that happen, the veneers may expand unevenly and give the plywood a twisted or uneven look. Moreover, the moisture absorbed in the veneers may contribute to mold growth, thereby corrupting the plywood and rendering it useless.
3. In addition, the moisture sucked up in the veneers tends to adsorb sulfide in the air. Once the adsorbed sulfide combines with water to form sulfuric acid, the adhesive between the veneers will deteriorate, embrittle, or even peel off when the plywood is unduly loaded or forcibly struck. As a result, the structural integrity of the plywood will be seriously impaired, and the plywood will lose its intended bearing or supporting capacity.

Therefore, it is an important subject in the plywood industry to overcome the aforesaid drawbacks of the prior art and provide a novel board structure which not only has a three-dimensional structural strength equivalent to that of natural wood, but also is waterproof and mold-resistant due to its three-dimensionally bonded compact structure that prevents external moisture from entering the plywood through the gaps in the veneers.

### BRIEF SUMMARY OF THE INVENTION

In view of the aforementioned shortcomings of the prior art, the inventor of the present invention put years of practical experience into research and experiment and finally succeeded in developing a three-dimensional board structure and a method for making the same. It is hoped that the present invention will effectively solve the drawbacks of the conventional plywood such as potential warpage or deformation under heavy load or impact, delamination of veneers, and the various problems resulting from the absorption of external moisture by the relatively less compact plywood veneers.

It is an object of the present invention to provide a three-dimensional board structure, wherein the board structure is composed of a plurality of veneers containing plant fibers; an adhesive is applied between each two adjacent veneers; penetrated portions are provided at corresponding positions of the veneers; and the plant fibers around the peripheries of the penetrated portions of each veneer are entangled with the plant fibers around the peripheries of the penetrated portions of the adjacent veneer(s), thereby forming three-dimensional connecting portions in the three-dimensional board structure. The three-dimensional connecting portions correspond in number to the penetrated portions and are also filled with the adhesive. Thus, in addition to the two-dimensional bonding strength provided by the adhesive applied between each two adjacent veneers, the three-dimensional board structure has a three-dimensional bonding strength provided by the three-dimensional connecting portions between adjacent veneers. With increased compactness and an enhanced structural strength equivalent to the three-dimensional structural strength of natural wood, the three-dimensional board structure of the present invention can effectively resist warpage, deformation, and impact and is prevented from delamination of veneers. Furthermore, the three-dimensional connecting portions are so densely distributed that it is difficult for external moisture to penetrate the board structure along the plant fibers. Consequently, the three-dimensional board structure is also waterproof and mold-resistant while the adhesive is prevented from deterioration or embrittlement.

It is another object of the present invention to provide a method for making the aforesaid three-dimensional board structure and thereby enable manufacturers to produce such board structures easily.

### BRIEF DESCRIPTION OF THE SEVERAL VIEWS OF THE DRAWINGS

A detailed description of further features, objects, and advantages of the present invention is given below with reference to the accompanying drawings, in which:

FIG. 1 is a schematic drawing of a three-dimensional board structure according to a first preferred embodiment of the present invention and a tool for making the same;

FIG. 2 is the flowchart of a method for making the three-dimensional board structure of the first preferred embodiment with the tool shown in FIG. 1;

FIG. 3 is a schematic drawing of a three-dimensional board structure according to a second preferred embodiment of the present invention and a tool for making the same; and

FIG. 4 is a schematic drawing of a three-dimensional board structure according to a third preferred embodiment of the present invention and a tool for making the same.

### DETAILED DESCRIPTION OF THE INVENTION

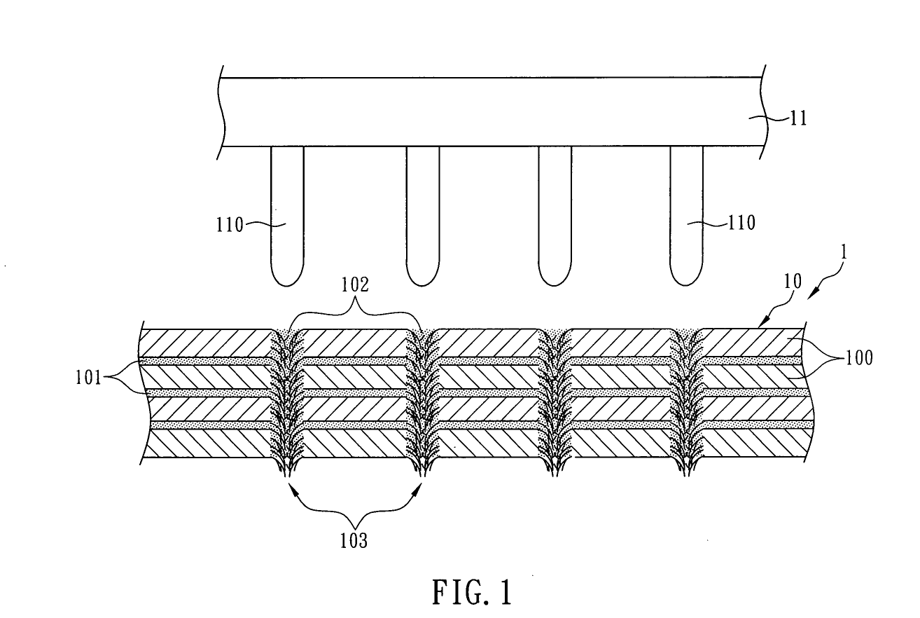

The present invention relates to a three-dimensional board structure and a method for making the same. In the first preferred embodiment of the present invention, referring to FIG. 1, a three-dimensional board structure 1 is composed of a plurality of veneers 100 which contain plant fibers. The veneers 100 are either peeled from tree trunks or branches or are made by connecting leaves or plant debris together. Each veneer 100 has a thickness ranging from 0.2 mm to 2.25 mm. An adhesive 101 is applied between each two adjacent veneers 100, wherein the adhesive 101 is a glue, resin, or tacky fluid. In addition, a plurality of equally or unequally spaced, penetrated portions 102 are provided at corresponding positions of the veneers 100. The plant fibers around the peripheries of the penetrated portions 102 of each veneer 100 are entangled with the plant fibers around the peripheries of the penetrated portions 102 of the adjacent veneer(s) 100, such that equally or unequally spaced three-dimensional connecting portions 103 are formed in the three-dimensional board structure 1 and correspond in number to the penetrated portions 102. Each three-dimensional connecting portion 103 is also filled with the adhesive 101.

The adhesive 101 applied between each two adjacent veneers 100 penetrates the corresponding surfaces thereof and, when dried, provides a two-dimensional bonding strength therebetween. Besides, due to the three-dimensional connecting portions 103 formed between the veneers 100, the plant fibers around the peripheries of the three-dimensional connecting portions 103 of each two adjacent veneers 100 are entangled. The entanglement of the plant fibers works in conjunction with the adhesive 101 to further bond each two adjacent veneers 100 together and provide a three-dimensional bonding strength, which is perpendicular to the two-dimensional bonding strength and goes deep into the adjacent veneers 100. Therefore, in addition to increased compactness, the three-dimensional board structure 1 is endowed with an enhanced structural strength equivalent to the three-dimensional structural strength of natural wood and achieves the following:

1. With each two adjacent veneers 100 firmly bonded to each other, the three-dimensional board structure 1 can effectively resist warpage, deformation, and impact; is prevented from delamination of veneers 100; and therefore has an extended service life.

2. The densely distributed three-dimensional connecting portions 103 effectively increase the closeness between the veneers 100 and hence prevent external moisture from entering the board structure 1 along the plant fibers, thereby providing the board structure 1 with waterproofness and mold-resistance. Furthermore, as the veneers 100 are prevented from uneven expansion which may otherwise result from moisture absorption by the veneers 100 and deform the board structure 1, the service life of the board structure 1 is significantly increased.

3. As stated above, the veneers 100 of the board structure 1 will not absorb and retain moisture, which may otherwise form sulfuric acid with sulfide in the air and lead to deterioration or embrittlement of the adhesive 101. Hence, the structural integrity and strength of the board structure 1 can stay stable, thereby maintaining the bearing or supporting ability of the board structure 1 for a long time.

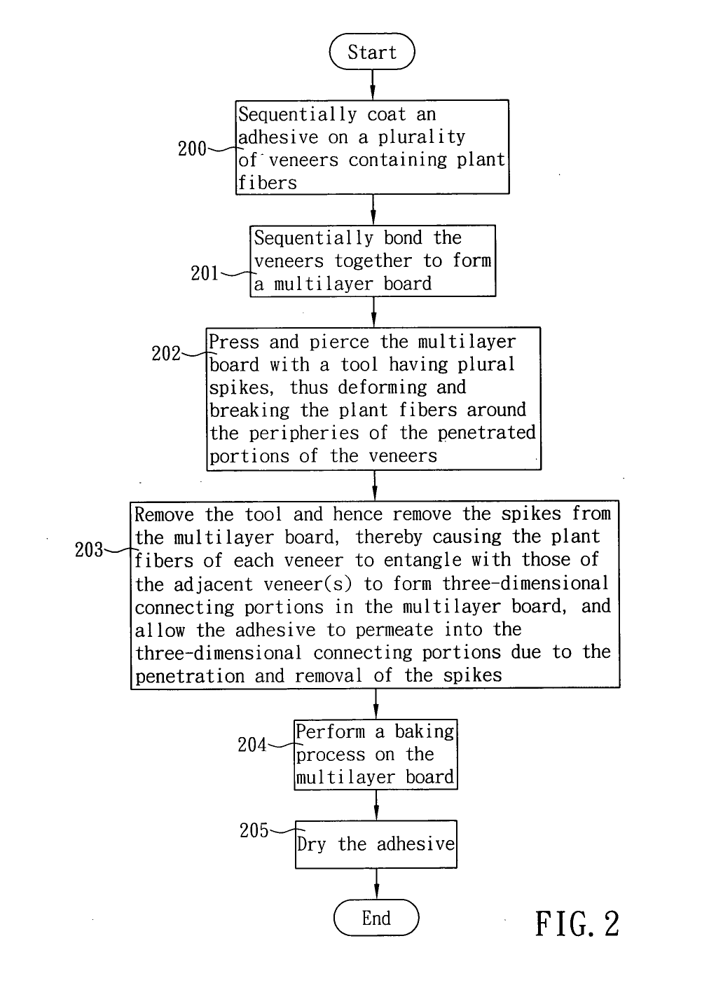

Referring to FIG. 2 in conjunction with FIG. 1, a method for making the three-dimensional board structure 1 of the present embodiment includes the following steps:

Step 200: A plurality of veneers 100 which contain plant fibers are sequentially coated with an adhesive 101.
Step 201: The veneers 100 are sequentially bonded together to form a multilayer board 10.
Step 202: The multilayer board 10 is pressed and pierced from one side thereof by a tool 11 with a plurality of spikes 110. The spikes 110 penetrate the veneers 100 sequentially and jut out from the opposite side of the multilayer board 10, thereby deforming and breaking the plant fibers around the peripheries of the penetrated portions 102 of the veneers 100.
Step 203: The tool 11 is removed such that the spikes 110 are separated from the multilayer board 10. As a result, the plant fibers around the peripheries of the penetrated portions 102 of each veneer 100 are entangled with those around the peripheries of the penetrated portions 102 of the adjacent veneer(s) 100, and three-dimensional connecting portions 103 that correspond in number to the penetrated portions 102 are thus formed. The penetration and removal of the spikes 110 also allow the adhesive 101 between each two adjacent veneers 100 to permeate into the corresponding three-dimensional connecting portions 103.
Step 204: A baking process is performed on the multilayer board 10 via a baking apparatus (e.g., a hot-air dryer, not shown).
Step 205: After the adhesive 101 is dried, the three-dimensional board structure 1 of the present invention is formed.

With the foregoing steps, manufacturers can easily produce the three-dimensional board structure 1 having a three-dimensional structural strength equivalent to that of natural wood.

Referring again to FIG 2. and FIG. 1, in the present embodiment, the manufacturing process can be shortened and simplified by omitting the Step 204 of performing a baking process on the multilayer board 10. In that case, the adhesive 101 can be air-dried instead to effectively lower the production costs of the three-dimensional board structure 1.

As shown in FIG. 1, the tool 11 for making the three-dimensional board structure 1 by the aforesaid manufacturing process is shaped as a flat panel and has the spikes 110 arranged on its bottom side. Thus, the tool 11, when moved downward toward the multilayer board 10, can press and pierce the multilayer board 10 at the same time. The tool 11 can be a large die configured for performing the pressing and piercing process on the entire multilayer board 10 or, alternatively, be a small die configured for pressing and piercing the multilayer board 10 in a section-by-section manner, such as by moving the multilayer board 10 stepwise with respect to the tool 11. In the present embodiment, the spikes 110 are arranged on the bottom side of the tool 11 at equal spacing and have rounded tips. Therefore, when the veneers 100 are penetrated by the spikes 110, the penetrated portions 102 of the veneers 100 are also equally spaced; moreover, the plant fibers around the peripheries of the penetrated portions 102 of each veneer 100 are bent toward the bottom side of each said veneer 100 (i.e., toward the top side of the immediately underlying veneer 100) by the downward movement of the spikes 110 and are entangled with the plant fibers around the peripheries of the penetrated portions 102 of the immediately underlying veneer 100. Thus, the three-dimensional connecting portions 103 are formed in the three-dimensional board structure 1 and are equally spaced, too.

It should be pointed out that the structure and shape of the tool 11 and the spikes 110, as well as the arrangement of the spikes 110 on the tool 11, are not limited to those disclosed herein and can be modified according to practical needs, as long as the tool 11 in conjunction with and the spikes 110 is capable of pressing and piercing the multilayer board 10 and forming the three-dimensional connecting portions 103 in the three-dimensional board structure 1. Two more embodiments of the present invention follow:

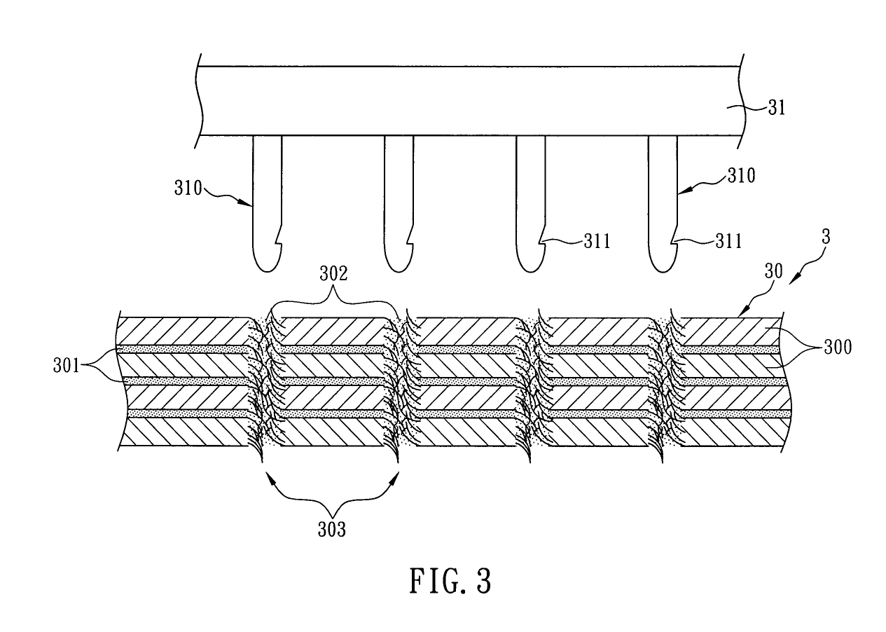

Please refer to FIG. 3 for the second preferred embodiment of the present invention, wherein the spikes 310, though shown as having rounded tips, may have beveled, conical, or otherwise-shaped tips instead, and each spike 310 is laterally provided with a groove or barb 311. When the veneers 300 are penetrated by the spikes 310, the plant fibers around the peripheries of the penetrated portions 302 of each veneer 300 are bent toward the bottom side of each said veneer 300 (i.e., toward the top side of the immediately underlying veneer 300) and are entangled with the plant fibers around the peripheries of the penetrated portions 302 of the immediately underlying veneer 300. When the spikes 310 with the lateral grooves or barbs 311 are subsequently pulled upward and removed from the multilayer board 30, the grooves or barbs 311 pull the corresponding plant fibers around the peripheries of the penetrated portions 302 of each veneer 300 toward the top side of each said veneer 300 (i.e., toward the bottom side of the immediately overlying veneer 300). As a result, the plant fibers around the peripheries of the penetrated portions 302 of the veneers 300 are intertwined in both upward and downward directions to form the three-dimensional connecting portions 303 in the three-dimensional board structure 3.

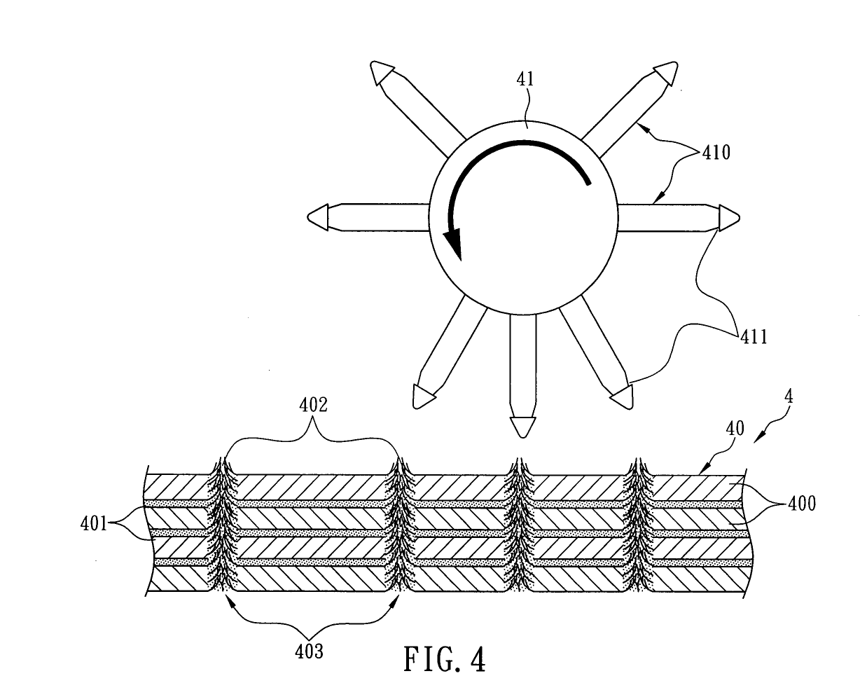

Referring to FIG. 4 for the third preferred embodiment of the present invention, the roller-shaped tool 41 has a surface provided with unequally spaced spikes 410. The tip of each spike 410 is conical but may also be rounded, beveled, or otherwise. Moreover, each spike 410 is laterally and circumferentially provided with a plurality of grooves or barbs 411. The tool 41 simultaneously presses and pierces the multilayer board 40 in a rolling manner. When the veneers 400 are penetrated by the spikes 410, unequally spaced penetrated portions 402 are formed. Due to the downward movement of the spikes 410, the plant fibers around the peripheries of the penetrated portions 402 of each veneer 400 are bent toward the bottom side of each said veneer 400 (i.e., toward the top side of the immediately underlying veneer 400) and are entangled with the plant fibers around the peripheries of the penetrated portions 402 of the immediately underlying veneer 400. When the spikes 410 are subsequently pulled upward and removed from the multilayer board 40, the grooves or barbs 411 laterally and circumferentially provided on the spikes 410 pull the corresponding plant fibers around the peripheries of the penetrated portions 402 of each veneer 400 toward the top side of each said veneer 400 (i.e., toward the bottom side of the immediately overlying veneer 400). Thus, the plant fibers around the peripheries of the penetrated portions 402 of the veneers 400 are intertwined in both upward and downward directions to form the unequally spaced three-dimensional connecting portions 403 in the three-dimensional board structure 4. In short, with reference to FIG. 1, the board structure 1 of the present invention is formed with the three-dimensional connecting portions 103 and therefore endowed with a three-dimensional structural strength equivalent to that of natural wood. With higher structural strength than the conventional plywood, the board structure 1 can effectively resist warpage, deformation, and impact and is prevented from delamination of the veneers 100. The densely distributed three-dimensional connecting portions 103 also prevent external moisture from entering the board structure 1 via the plant fibers and hence provide waterproofness and resistance to mold, thereby extending the service life of the board structure 1.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A method for making a three-dimensional board structure, comprising steps of:
sequentially coating a plurality of veneers with an adhesive, wherein each said veneer contains plant fibers;
sequentially bonding the veneers together to form a multilayer board;
pressing and piercing the multilayer board, from one side thereof, by using a tool provided with a plurality of spikes, such that the spikes penetrate the veneers sequentially, jut out from an opposite side of the multilayer board, and thereby deform and break the plant fibers around peripheries of penetrated portions of the veneers;
removing the tool and hence removing the spikes from the multilayer board, such that the plant fibers around the peripheries of the penetrated portions of each said veneer are entangled with the plant fibers around the peripheries of the penetrated portions of adjacent said veneer(s), thereby forming three-dimensional connecting portions corresponding in number to the penetrated portions, and that the penetration and the removal of the spikes cause the adhesive between each two adjacent said veneers to permeate into corresponding said three-dimensional connecting portions; and
drying the adhesive.

2. The method of claim 1, wherein each said spike has a tip laterally provided with at least a groove or barb.

3. The method of claim 2, wherein the tool is shaped as a flat panel, and the spikes are provided at a bottom side of the tool.

4. The method of claim 2, wherein the tool is roller-shaped, and the spikes are provided on a surface of the tool.

5. The method of claim 3, wherein the spikes are equally or unequally spaced on the tool.

6. The method of claim 4, wherein the spikes are equally or unequally spaced on the tool.

7. The method of claim 5, further comprising, before the adhesive is dried:
performing a baking process on the multilayer board via a baking apparatus.

8. The method of claim 6, further comprising, before the adhesive is dried:
performing a baking process on the multilayer board via a baking apparatus.

9. A three-dimensional board structure, composed of a plurality of veneers, each said veneer containing plant fibers, wherein an adhesive is applied between each two adjacent said veneers, a plurality of penetrated portions are provided at corresponding positions of the veneers, and the plant fibers around peripheries of the penetrated portions of each said veneer are entangled with the plant fibers around the peripheries of the penetrated portions of adjacent said veneer(s) to form three-dimensional connecting portions in the three-dimensional board structure, which correspond in number to the penetrated portions and are filled with the adhesive.

10. The three-dimensional board structure of claim 9, wherein the three-dimensional connecting portions are equally or unequally spaced in the three-dimensional board structure.

11. The three-dimensional board structure of claim 10, wherein each said veneer has a thickness ranging from 0.2 mm to 2.25 mm.
